(19) United States
(12) Patent Application Publication
(10) Pub. No.: US 2015/0207824 A1
(43) Pub. Date: Jul. 23, 2015

(54) FRAMEWORK FOR CREATING AD-HOC LOCATION CONSTRAINED MUSIC CHANNELS

(71) Applicant: Nokia Corporation, Espoo (FI)

(72) Inventors: Sailesh Sathish, Bangalore (IN); Jilei Tian, Beijing (CN)

(73) Assignee: Nokia Corporation

(21) Appl. No.: 14/402,160

(22) PCT Filed: May 25, 2012
(86) PCT No.: PCT/CN2012/076100

§ 371 Date: Nov. 19, 2014

(51) Int. Cl. H04L 29/06; H04W 84/18

(52) U.S. Cl. CPC H04L 65/1069; H04W 84/18; H04L 65/4084

(57) ABSTRACT

A method for creating and managing ad-hoc context constrained music channels is described. The method includes, in response to a request to initiate a music channel, determining whether music content available for the music channel is relevant and/or sufficient. At least one piece of the music content available is stored in a memory controlled by a user of the music channel. The method also includes, in response to determining that music content available is relevant and/or sufficient, creating the music channel. Apparatus and computer readable media are also described.

### TECHNICAL FIELD

The exemplary and non-limiting embodiments relate generally to wireless communication systems, methods, devices and computer programs and, more specifically, relate to creating and managing ad-hoc context constrained music channels.

### BACKGROUND

This section is intended to provide a background or context. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

API application programming interface

BW bandwidth

DL downlink (towards UE)

DP data processor

DSP digital signal processors

MEM memory

PROG program

RF radio frequency

UE user equipment, such as a mobile station or mobile terminal

UI user interface

UL uplink (away from UE)

Currently, online music communities are defined based on social aspects/characteristics, such as membership in a social network. This presents restrictions on the use of the online music communities (for example, by requiring users having internet access). Additionally, such communities do not consider the full range of possible characteristics when being established. Therefore, the current online music communities lack flexibility that may be used to better serve their members.

### SUMMARY

The below summary section is intended to be merely exemplary and non-limiting.

The foregoing and other problems are overcome, and other advantages are realized, by the use of the exemplary embodiments.

In a first aspect thereof an exemplary embodiment provides a method for creating and managing ad-hoc context constrained music channels. The method includes, in response to a request to initiate a music channel, determining whether music content available for the music channel is relevant and sufficient, for example, by meeting various criteria. At least one piece of the music content available is stored in a memory controlled by a user of the music channel. The method also includes, in response to determining that music content available is relevant and sufficient, creating the music channel.

In another aspect thereof an exemplary embodiment provides an apparatus for creating and managing ad-hoc context constrained music channels. The apparatus includes at least one processor; and at least one memory storing computer program code. The at least one memory and the computer program code are configured to, with the at least one processor, cause the apparatus to perform actions. The actions include, in response to a request to initiate a music channel, to determine whether music content available for the music channel is relevant and sufficient. At least one piece of the music content available is stored in a memory controlled by a user of the music channel. The actions also include, in response to determining that music content available is relevant and sufficient, to create the music channel.

In a further aspect thereof an exemplary embodiment provides a computer readable medium for creating and managing ad-hoc context constrained music channels. The computer readable medium is tangibly encoded with a computer program executable by a processor to perform actions. The actions include, in response to a request to initiate a music channel, determining whether music content available for the music channel is relevant and sufficient. At least one piece of the music content available is stored in a memory controlled by a user of the music channel. The actions also include, in response to determining that music content available is relevant and sufficient, creating the music channel.

In another aspect thereof an exemplary embodiment provides an apparatus for creating and managing ad-hoc context constrained music channels. The apparatus includes means for determining whether music content available for the music channel is relevant and sufficient in response to a request to initiate a music channel. At least one piece of the music content available is stored in a memory controlled by a user of the music channel. The apparatus also includes means for creating the music channel in response to determining that music content available is relevant and sufficient.

In a further aspect thereof an exemplary embodiment provides a method for creating and managing ad-hoc context constrained media channels. The method includes generating a list of pieces of media content stored in a memory. The list includes an indication of at least one piece of media content that is authorized to be shared. The method also includes sending the list to a media channel server.

In another aspect thereof an exemplary embodiment provides an apparatus for creating and managing ad-hoc context constrained media channels. The apparatus includes at least one processor; and at least one memory storing computer program code. The at least one memory and the computer program code are configured to, with the at least one processor, cause the apparatus to perform actions. The actions include to generate a list of pieces of media content stored in a memory. The list includes an indication of at least one piece of media content that is authorized to be shared. The actions also include to send the list to a media channel server.

In a further aspect thereof an exemplary embodiment provides a computer readable medium for creating and managing ad-hoc context constrained media channels. The computer readable medium is tangibly encoded with a computer program executable by a processor to perform actions. The actions include generating a list of pieces of media content stored in a memory. The list includes an indication of at least one piece of media content that is authorized to be shared. The actions also include sending the list to a media channel server.

In another aspect thereof an exemplary embodiment provides an apparatus for creating and managing ad-hoc context constrained media channels. The apparatus includes means for generating a list of pieces of media content stored in a memory. The list includes an indication of at least one piece of media content that is authorized to be shared. The apparatus also includes means for sending the list to a media channel server.

### BRIEF DESCRIPTION OF THE DRAWINGS

The foregoing and other aspects of exemplary embodiments are made more evident in the following Detailed Description, when read in conjunction with the attached Drawing Figures, wherein:

FIG. 1 shows a simplified block diagram of exemplary electronic devices that are suitable for use in practicing various exemplary embodiments.

FIG. 2 shows a more particularized block diagram of an exemplary user equipment such as that shown at FIG. 1.

FIG. 3 is an exemplary signaling diagram in accordance with an exemplary embodiment.

FIG. 4 illustrates an exemplary server framework in accordance with an exemplary embodiment.

FIG. 5 shows an exemplary UI in accordance with an exemplary embodiment

FIG. 6 is a logic flow diagram that illustrates the operation of an exemplary method, and a result of execution of computer program instructions embodied on a computer readable memory, in accordance with various exemplary embodiments.

### DETAILED DESCRIPTION

Various exemplary embodiments enable situation-aware music service experiences. More specifically, some embodiments may be used to build an ad-hoc community with common characteristics in order to share a music channel/radio. These characteristics may be based on location (such as, people in the same mall, in the same building, on the same flight/train, etc.) and/or based on user activity (such as, jogging, playing a sport, at a party, shopping, etc.). The music channel/radio may be automatically formed using a music collection, online streaming and/or ‘real time’ playing from the users in the defined community.

The user music discovery experience may leverage mobile features (such as, location, etc.) in order to define and/or find a location based ad-hoc music sharing community. The music discovery experience can create an ad-hoc music sharing community for mobile users sharing certain characteristics, such as those in the same flight/train, or even generalized to broadly defined situation, such as, users at a concert, user watching a sport in a stadium, etc.

In another exemplary embodiment, a server/music system may provide an interface for a plurality of communities. The list of supported communities may be provided in a community catalog. By having a community catalog, the system is able to simultaneously serve different music service requests, such as playlist recommendations, music channels/radios, etc.

Additionally, the server may monitor one or more communities. The server may use this information to better anticipate music channel/radio requests and/or to then provide details on the community (such as, which songs are requested most, which channels are most popular, etc.). Since a music channel/radio is community based, businesses can also benefit from understanding the community characteristics (or demographics), for example, by offering special discounts for limited groups of people, providing mobile targeted advertisement, etc.

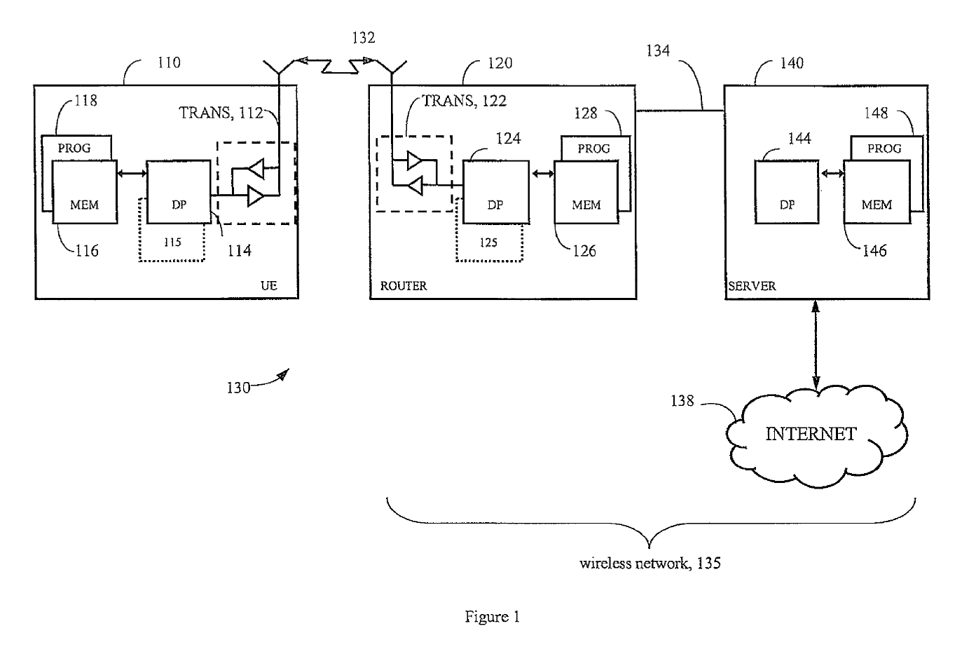

Before describing in further detail various exemplary embodiments, reference is made to FIG. 1 for illustrating a simplified block diagram of various electronic devices and apparatus that are suitable for use in practicing exemplary embodiments.

In the wireless system 130 of FIG. 1, a wireless network 135 is adapted for communication over a wireless link 132 with an apparatus, such as a mobile communication device which may be referred to as a UE 110, via a network access node, such as a router 120. The network 135 may include a server 140 that may provide connectivity with a network, such as a local data communications network and/or the internet 138).

The UE 110 includes a controller, such as a computer or a data processor (DP) 114, a computer-readable memory medium embodied as a memory (MEM) 116 that stores a program of computer instructions (PROG) 118, and a suitable wireless interface, such as radio frequency (RF) transceiver 112, for bidirectional wireless communications with the router 120 via one or more antennas.

The router 120 also includes a controller, such as a computer or a data processor (DP) 124, a computer-readable memory medium embodied as a memory (MEM) 126 that stores a program of computer instructions (PROG) 128, and a suitable wireless interface, such as RF transceiver 122, for communication with the UE 110 via one or more antennas. The router 120 is coupled via a data/control path 134 to the server 140.

The server 140 includes a controller, such as a computer or a data processor (DP) 144, a computer-readable memory medium embodied as a memory (MEM) 146 that stores a program of computer instructions (PROG) 148.

At least one of the PROGs 118, 128 and 148 is assumed to include program instructions that, when executed by the associated DP, enable the device to operate in accordance with exemplary embodiments, as will be discussed below in greater detail.

That is, various exemplary embodiments may be implemented at least in part by computer software executable by the DP 114 of the UE 110; by the DP 124 of the router 120; and/or by the DP 144 of the server 140, or by hardware, or by a combination of software and hardware (and firmware).

The UE 110 and the router 120 may also include dedicated processors, for example music sharing processor 115 and music sharing processor 125.

In general, the various embodiments of the UE 110 can include, but are not limited to, cellular telephones, tablets having wireless communication capabilities, personal digital assistants (PDAs) having wireless communication capabilities, portable computers having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 116, 126 and 146 may be of any type suitable to the local technical environment and may be implemented using any suitable data storage technology, such as semiconductor based memory devices, flash memory, magnetic memory devices and systems, optical memory devices and systems, fixed memory and removable memory. The DPs 114, 124 and 144 may be of any type suitable to the local technical environment, and may include one or more of general purpose computers, special purpose computers, microprocessors, digital signal processors (DSPs) and processors based on a multicore processor architecture, as non-limiting examples. The wireless interfaces (e.g., RF transceivers 112 and 122) may be of any type suitable to the local technical environment and may be implemented using any suitable communication technology such as individual transmitters, receivers, transceivers or a combination of such components.

While, as shown, the router 120 is separate from the server 140, in another embodiment these elements may be combined into a single device. The functionality of DP 124 and 144 may be performed by a single DP. Similarly, MEMs 126 and 146 and PROGs 128 and 148 may also be combined.

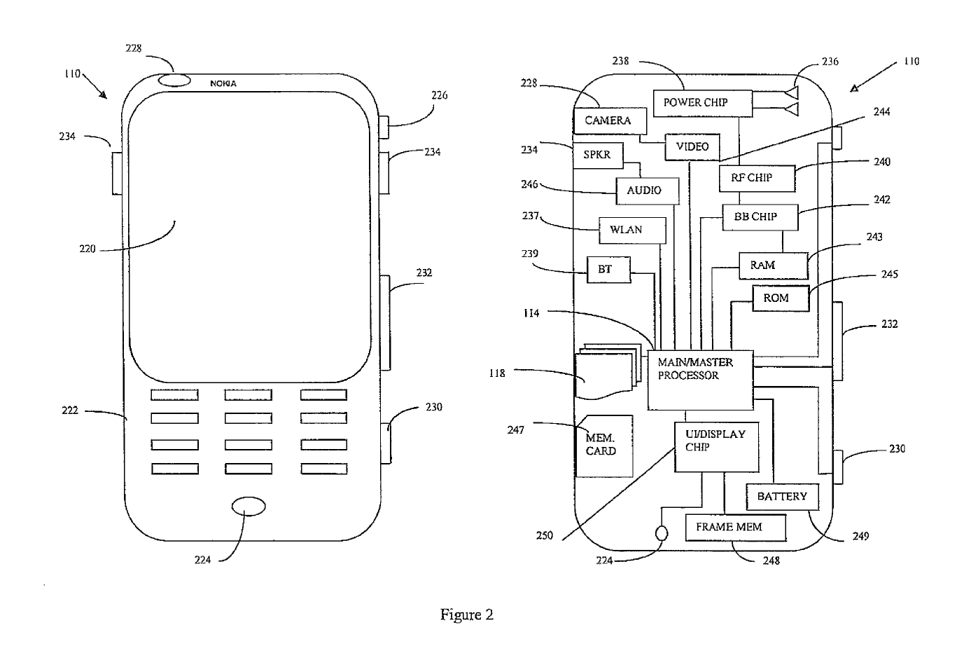

FIG. 2 illustrates further detail of an exemplary UE in both plan view (left) and sectional view (right), and an exemplary embodiment may be embodied in one or some combination of those more function-specific components. At FIG. 2 the UE 110 has a graphical display interface 220 and a user interface 222 illustrated as a keypad but understood as also encompassing touch-screen technology at the graphical display interface 220 and voice-recognition technology received at the microphone 224. A power actuator 226 controls the device being turned on and off by the user. The exemplary UE 110 may have a camera 228 which is shown as being forward facing (e.g., for video calls) but may alternatively or additionally be rearward facing (e.g., for capturing images and video for local storage). The camera 228 is controlled by a shutter actuator 230 and optionally by a zoom actuator 232 which may alternatively function as a volume adjustment for the speaker(s) 234 when the camera 228 is not in an active mode.

Within the sectional view of FIG. 2 are seen multiple transmit/receive antennas 236 that are typically used for cellular communication. The antennas 236 may be multi-band for use with other radios in the UE. The operable ground plane for the antennas 236 is shown by shading as spanning the entire space enclosed by the UE housing though in some embodiments the ground plane may be limited to a smaller area, such as disposed on a printed wiring board on which the power chip 238 is formed. The power chip 238 controls power amplification on the channels being transmitted and/or across the antennas that transmit simultaneously where spatial diversity is used, and amplifies the received signals. The power chip 238 outputs the amplified received signal to the radio-frequency (RF) chip 240 which demodulates and downconverts the signal for baseband processing. The baseband (BB) chip 242 detects the signal which is then converted to a bit-stream and finally decoded. Similar processing occurs in reverse for signals generated in the apparatus 110 and transmitted from it.

Signals to and from the camera 228 pass through an image/video processor 244 which encodes and decodes the various image frames. A separate audio processor 246 may also be present controlling signals to and from the speakers 234 and the microphone 224. The graphical display interface 220 is refreshed from a frame memory 248 as controlled by a user interface chip 250 which may process signals to and from the display interface 220 and/or additionally process user inputs from the keypad 222 and elsewhere.

Certain embodiments of the UE 110 may also include one or more secondary radios such as a wireless local area network radio WLAN 237 and a Bluetooth® radio 239, which may incorporate an antenna on-chip or be coupled to an off-chip antenna. Throughout the apparatus are various memories such as random access memory RAM 243, read only memory ROM 245, and in some embodiments removable memory such as the illustrated memory card 247. The various programs 118 are stored in one or more of these memories. All of these components within the UE 110 are normally powered by a portable power supply such as a battery 249.

Processors 238, 240, 242, 244, 246, 250, if embodied as separate entities in a UE 110 or router 120, may operate in a slave relationship to the main processor 114, 124, which may then be in a master relationship to them. Embodiments are most relevant to the audio processor 246, though it is noted that other embodiments need not be disposed there but may be disposed across various chips and memories as shown or disposed within another processor that combines some of the functions described above for FIG. 2. Any or all of these various processors of FIG. 2 access one or more of the various memories, which may be on-chip with the processor or separate therefrom. Similar function-specific components that are directed toward communications over a network broader than a piconet (e.g., components. 236, 238, 240, 242-245 and 247) may also be disposed in exemplary embodiments of the access node 120, which may have an array of tower-mounted antennas rather than the two shown at FIG. 2.

Note that the various chips (e.g., 238, 240, 242, etc.) that were described above may be combined into a fewer number than described and, in a most compact case, may all be embodied physically within a single chip.

Various exemplary embodiments enable the ad-hoc creation and management of media channels. The channels may be location dependent and/or depend on other context characteristics. Use of mobile devices and location information allow a scalable architecture with highly localized flavor that is suitable for emerging and developed markets. Additionally, the service provides an ability for third party providers to supply localized content and to monetize the music channel.

Channels may be created in an ad-hoc manner. Channels can be created, modified and destroyed depending on settings applied for creating the channel as well as channel heuristics. Channels heuristics may be provided by the administrator (or owner for a channel) and are a set of logical instructions and constraints that define when and how a channel can be created.

Typically, a channel may be created when there is a sufficient quantity of music available to create that channel. The channel can be created when a certain threshold is exceeded. For example, for a Chinese traditional classical music channel, the threshold may be at least 30 minutes of music available from different sources.

The channel creation parameters can be provided by the administrator (or channel creator). Below is a non-limiting example of a channel creation declaration in XML format (though other formats are possible). The service may provide a user interface (UI) for setting up the channel creation declaration (such as, on the server side) which can then properly format the channel creation declaration.

In addition, a client may also have an optional UI for creating/requesting a new channel if that particular channel is not available. The creation of channels by a client may be conditional upon the ability of the client to provide content for that channel. When the service has other music that could not previously be matched to any channel, the service may check whether one or more of the available music can be mapped to the new channel definition. If so, they may be added in the new channel.

The creation of ad-hoc music channels may be based on various characteristics. For example, a music channel may be created based on the amount of music available to the service when the ad-hoc channels are created. The amount of music may be defined as a number of individual music pieces and/or as total play time of all pieces.

Additionally, an ad-hoc music channel may be constrained to one or more context, such as specific locations or boundaries with respect to specific location technologies. For example, users of the ad-hoc music channel may be limited to those within a given geographical location/boundary, users accessing the service through a given wireless access point (thus, limiting the area the user may be in).

A non-limiting exemplary declaration for creating a new music channel is as follows:

<channelName>Chinese Classical</channelName>
<channelType>Traditional Classic</channelType>
<channelLanguage>Chinese</channelLanguage>
<channelDuration>no limit</channelDuration>
<creationContentThreshold time=minutes>30</creationContentThreshold>
<channelOwner>mmmmmm</channelOwner>
<channelFeedType>streaming</channelFeedType>
<maxUserNo>25</maxUserNo>
<minUserNo>1</minUserNo>
<mediaLoop value=no />
<allowPaidContent>no</allowPaidContent>
<contextRestrictions>

<locationRestriction>
<centralCoords type=GPS range=300M>

<lat>..</lat>
<long>..</long>

</centralCoords>
</locationRestriction>
<timeRestriction>

<startTime>..</startTime>
<endTime>...</endTime>

<timeRestriction>

</contextRestrictions>
<groupRestrictions>
</groupRestrictions>

The declaration provided may be used to create a channel titled “Chinese Classical”. The language for the channel will be set to Chinese and the music constrained to traditional classical music. The channel will require at least 30 minutes of play time available. Additionally, the minimum number of users for a channel has been set to be at least one user. No location restrictions, time restrictions or group restrictions are established.

The exemplary declaration provided above can be created with help of a map interface that maps the constraints into xml format and stores them for the channel. In addition, the map interface can also show service data, such as, user statistics, channels created, active channels, etc. Through the map, the administrator can pinpoint either a region (such as, by identifying a central coordinate) and/or define a range within which a channel will be active. The range can be given in meters for indoor purposes. Alternatively, the administrator can also choose a room or area within the building where the channel will be active.

Various exemplary embodiments provide a situation-aware music discovery service. The music discovery service may consider various user specific characteristics to greatly improve the user experience by more carefully tailoring to service to the user. More specifically, an ad-hoc community may be built for users with common characteristics, such as people shopping in the same mall, working in the same building, on the same flight/train, performing the same activities (such as, jogging, playing a sport and attending a party), etc.

The music channel/radio may be automatically formed using a standard music collection and/or online streaming. Additionally, the music channel/radio may include music provided by the users. This creates an interactive community which is defined in part by the current users of the music channel/radio. Users may provide music for real time playing while the user is connected to the music channel/radio.

By having community catalog, the system is able to provide different music services based on the current characteristics, of the community, such as to make playlist recommendations, music channels/radios, etc. Since the music channel/radio is community based, businesses can also benefit by understanding the community, for example, to make special discount offers for specific groups and/or for mobile targeted advertisement. By connecting the users who have the same semantic feeling and emotion, the system can make music discovery fun and a more social experience. This can further connect the people to the locations where the music channel/radio is offered.

A community can be determined in several ways. One technique is to combine individuals sharing a location, an activity and/or a WiFi access point. A WiFi AP may be named in a way that the name semantically identifies a place and an activity. This allows even inaccessible Wi-Fi signals to carry additional information, such as by identifying the business providing the WiFi AP. Users may use the name of the WiFi AP in order to decide whether or not they wish to connect.

The service may be formed in an ad-hoc manner when people log-in. Thus, the music supplied from a user is only temporarily shared. Due to the ad-hoc formation; sharing may be based on content supplied by the users.

Channel content may be collected and uploaded by the users sharing an activity. However, people may still be able to access the channel without joining the activity. Similarly, other characteristics of the group may be relaxed, such as location, etc. The system may allow the users of a music channel/radio to set these preferences and/or the system may be configured by an administrator.

The system may use a client-server architecture. Client software runs on the user device which is able to connect to a server providing the service (for simplicity, the term service may refer to both the server providing the service and the service itself). The service can also have one or more administrators and can have a local deployment (though the service is scalable globally).

In a non-limiting example, the geographically constrained environment is an office building. As a user enters the office building, his/her client (such as, an ad-hoc media channel client running on a user device) contacts the building service and receives a list of available music channels. The source of the music in the channel may be the music that is resident on other user devices that have joined the ad-hoc service. The user is shown a list of available channels. In addition, the client may inform the server of the music that is available locally on the user device (or accessible by the user device such as from the cloud).

There are different types of channels available, each channel can have a different behavior/type. As a non-limiting example, the channels may be classified based on at least the following types (other types can also be present): a) channels based on types of music, for example, Indian classical, Chinese classical, Chinese POP music, Latest Music, Western Jazz, etc.; b) channels based on music stream characteristics, for example, continuous streaming, on-demand, what other users are listening to currently, paid music, etc.; c) a combination of type of music and music stream characteristics, for example, on-demand Chinese POP music, Indian classical that other users are listening to currently, etc.; d) location constraints, for example, the user is at a particular location, such as, the auditorium, lobby or a particular meeting room in order to access the music; and/or e) group constraints, for example, the user is part of a team or group of people who are present in the building or constrained via a location.

The client software may provide an interface through which user can set sharing options for the music that they own and have rights to. Users can set for example, share all my music, share music of a given type (such as, classical music), share only free music, share only paid music, share music only for playback (for example, no download), ask every time for each music file when share requested, use only reciprocal share, etc. The constraints are intuitive enough that user can easily employ the share settings.

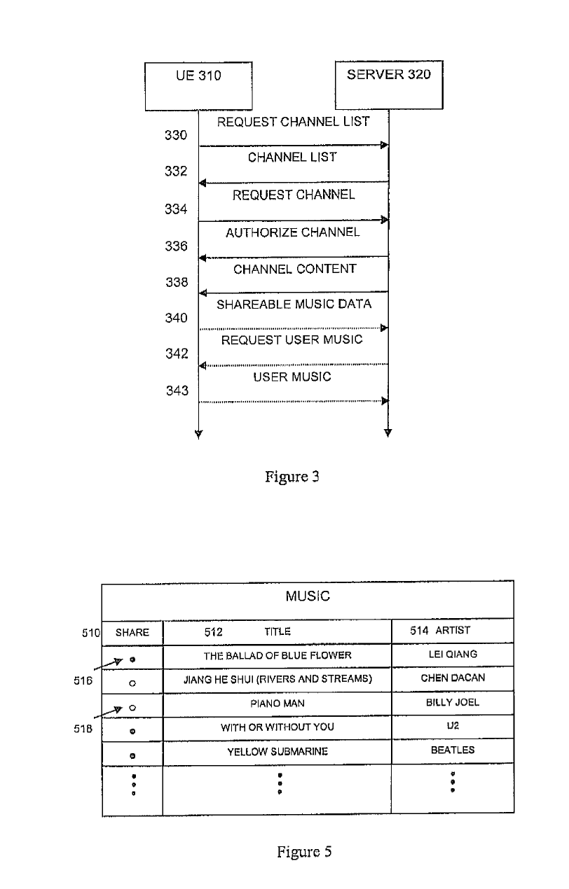

FIG. 3 is an exemplary signaling diagram in accordance with an exemplary embodiment. As shown, a mobile device, UE 310, is employed by a user in order to subscribe to a music service provided through server 320. UE 310 sends a request 330 for a list of available channels to server 320. The request may include additional information, such as a user ID, and/or preferred channel characteristics (for example, language, music classification, etc.). In response to the request 330, the server 320 supplies a channel list 332 of available channels. Server 320 may tailor the list to those authorized for UE 310 and/or based on various criteria identified in the request 330.

The user may select a channel from the channel list 332 and the UE 310 sends a request for that channel 334 to server 320. Once the user is authorized for access to the channel (for example based on user ID, limits on the number of users on the channel, characteristics of the user, etc.) and/or the channel is created (in case no such channel was created yet), the server 320 provides an authorization 336 to UE 310. The authorization 336 may include additional information regarding the channel, for example, frequency, security protocols, etc. Once the UE 310 receives the authorization 336, the UE 310 may begin to receive channel content 338.

Optionally, UE 310 may provide information regarding sharable music data 340 available from the UE 310 to the server 320. The server 320 may then send a request 342 that the UE 310 to provide one or more of the music data. The request 342 may identify a data channel the UE 310 may use to provide the music. The UE 310 can then transmit the requested user music 343 to the server 320 (alternatively, the UE 310 may provide the server 320 information so that the server 320 can access the user music on the cloud).

Another implementation option is to use representational state transfer (REST) style functionality. The server exposes a set of HTTP API's through the service interface module. The clients use HTTP requests such as a GET request with location data as a parameter along with optional credentials such as group information. The server parses the request and checks if channels are available for that user within the given context parameters. The parameters, for example, can be location and time as well as authentication information. The response to the GET request may be a “200 OK” response with a channel list as an optional payload. The channel list may contain an entry for each channel (such as an XML payload) where channel information for each channel may be presented, such as, type of channel, language, media type, service type (for example, streaming or content pull style), etc. The client can parse the response and build an appropriate display UI for the user. The user can then make a selection of the channel, where the selection request will be sent to server in another GET request. The client will then be given access to the channel data indicated via the “200 OK” response.

When a client sends a request for information regarding available channels, the request may contain client location information. The location information can be a list of WLAN IDs (such as those visible to the user), GPS data, triangulation data, Bluetooth IDs, etc. A location mapping module within the service maps the client location to representations supported by the service and maps the user to a location. Any active channels available within that location are then sent back to the client.

The server can also set group based restrictions. Groups are typically those that are formed or allowed within a company and users may belong to one or more groups. A group management module within the service manages groups, controls membership access and so forth. If a group constraint is provided in a channel definition, then the group module is consulted to check whether permission can be granted to a user requesting access to that channel. In addition, one or more users may be designated as group administrators and the service can route any group membership requests to the particular administrator (for example, a request to join a group).

When the client establishes a session with the local service, the service gets a list of shareable music available within the user device. Additionally, the service may receive meta-information about each piece of music. The meta-information can contain information such as length of music, time created, artist, genre, language etc. The client may choose to share all of their music with the service or limit the shareable music to a subset of music stored in the memory controlled by the user.

FIG. 5 shows an exemplary UI in accordance with an exemplary embodiment. As shown, a list of music items available on a mobile device is provided. The music items are described by various characteristics, such as, title and artist (additional characteristics may be shown, for example, music classification, album, music duration, etc.). Additional, for each music item, a button 516, 518 is provided in a ‘share’ column. The list shows a highlighted button. 516 for music items available for sharing and an empty button 518 for music items which are not to be shared. The headers for the columns 510, 512, 514 may be selected in order to sort the music items by that characteristic.

The service may receive music from the client device, put the music into an appropriate channel and then stream the music to other clients. A separate signaling and data channel may be established between the server and client. Alternatively, the server can also allow the client to directly source content from the source user so that the clients communicate with each other for the content. This causes the client to also act as a streaming server when providing local content. Clients may also re-establish connections with peers once a song has finished in order to source music from another client device.

Since music may be provided by the users, as users join the service and leave the service (such as, through opening and closing sessions with the service), so will the sources of music. The channel may guarantee a minimal QoS that allows a client to see a) how long the channel will be available (for example, at least 20 minutes which can be extended during that 20 minutes) and/or b) how many songs remain. Other channels may play songs in a loop with an expiration time such as, until 4 PM. When a channel begins streaming a song (for example, on a streaming music channel), the service may ensure that the song will be played in full even if the client who is providing that song disconnects the session during transmission of the song. As a non-limiting example, this can be done by pre-storing the song from the client device to the service before transmission in the channel (for example, in a buffer, downloading the song, etc.). A signaling channel between the source (such as, the client providing the music) and the service lets know the client that their song is being broadcast and may optionally provide details, such as, how many users are listening to it at that point.

The service may assign music to a particular channel based on the metadata definitions available within the meta-info content of the music. In cases where the metadata is not available, the service can fetch the information from third party sources, from the client itself and/or perform music classification analysis. The classified music is then compared to the channel definitions to see which channel (or channels) the music would match. The music can then be queued for transmission on the channel or put in a buffer (for example, to ensure a particular threshold for creation of that channel is met). The channel and buffer settings may be set by a system administrator and/or channel creator. The administrator can also set how many users can simultaneously listen on a particular channel (for example, a minimum number for channel creation, a maximum number of users on a channel, etc.).

There can be a local deployment of a service within a building that manages the ad-hoc channels. Clients are directed to this local deployment when they enter the building. This may be done by the client first contacting a central server where the server redirects the client to the local deployment server's IP address. The client may contact the city or country central server that has been pre-configured on the client device. Alternatively, the client device itself can be pre-loaded with an index of all local deployment address. The client software can then make a lookup of the correct server and then send the request accordingly.

External services can monitor requests for channels, for example, for the system to provide an ad-hoc channel such as a Chinese classical channel. If there isn't enough content available, the external service may choose to provide the content for that channel, for example, a service can provide classical songs to a channel in a mall when users request it. This may be done by making sufficient content available so that the system activates the channel. The external service can also provide advertisement through that channel in order to achieve a highly targeted reach.

The requests being monitored can be limited to those matching specific characteristics, for example, based on the location of the request (such as, requests which come from users in a mall), type of music (such as, requests for Chinese classical channels), etc. If there is insufficient content available, the external services can provide content to that channel. For example, CCTV3 can provide classical songs to a channel in a mall when users request a classical channel in order to make the content available sufficient enough to bring the channel on (for example, by exceeding a minimum content threshold). The external services can also provide advertisements through that channel.

In systems where monitoring is not allowed, external services can query the service to check the status of the channels. For example, a content provider can query “give list of top ten channels users are listening to” or “how many users are listening to Chinese classical music now” and so forth. The queries can be based on the type of content they have available and the level of service agreement between the content provider and the service provider.

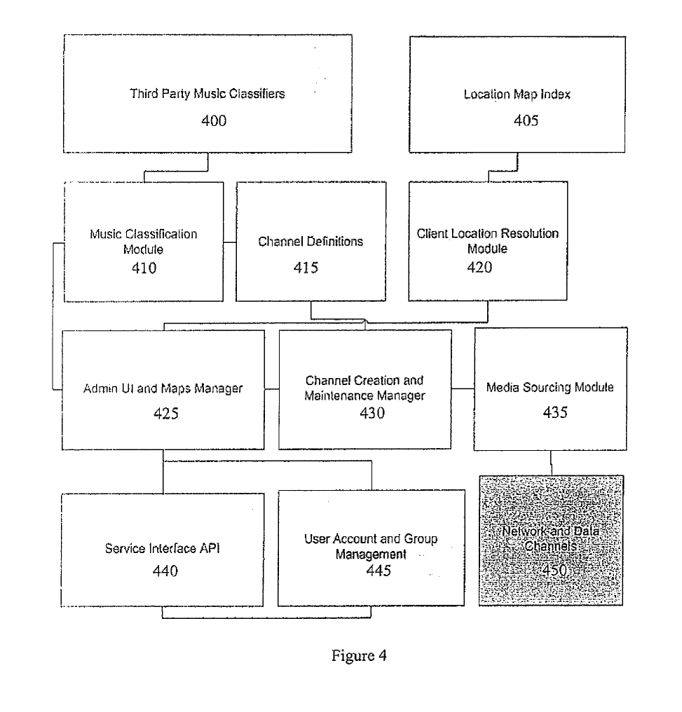

FIG. 4 illustrates an exemplary server framework in accordance with an exemplary embodiment. The server framework shows a variety of modules 400-450 that may be run on the server. A music classification module 410 may be used to clarify music, such as by consulting a third party music classifier module 400. A client location resolution module 420 may be used to determine the location of a user, such as by using a location map index module 405. Channels may be defined through the use of a channel definitions module 415. The media sourcing module 435 controls how music data is sourced for the channels and may access a network and data channels module 450 in order to receive and transmit media. The administration UI and maps manager module 425 may be used to set up server parameters (for example, location restrictions). Establishing and operating channels may be performed via a channel creation and maintenance manager module 430 while the service interface API module 440 provides a interface for operating the service. The user account and group management module 445 may be used to access/modify user accounts and to manage group memberships.

The music to be played on a music channel may be selected from the set of available music based on various factors, for example, based on requests for individual songs. Additionally, the service may perform a random selection of available music. The selection may also be weighted based on characteristics of the user from which the music is sourced. As a non-limiting example, the service may consider the amount of time the user has been continuously connected to the service. The service may wish to delay selection of a user until the user has been connected for a minimal time (such as 10 minutes) in order to avoid ‘temporary’ users who may change channels or leave the geographic area. Similarly, the service may wish to avoid selection of users that have been connected ‘too long’ (for example, users in a ‘workout’ activity community may not be expected to be connected for longer than an hour).

In traditional community based music sharing services the community is defined as the online community based on various social aspects. However, these services lack support for mobile features such as user activity, location, etc, and rely on access to the internet.

Based on the foregoing it should be apparent that various exemplary embodiments provide a method, apparatus and computer program(s) to creating and managing ad-hoc context constrained music channels.

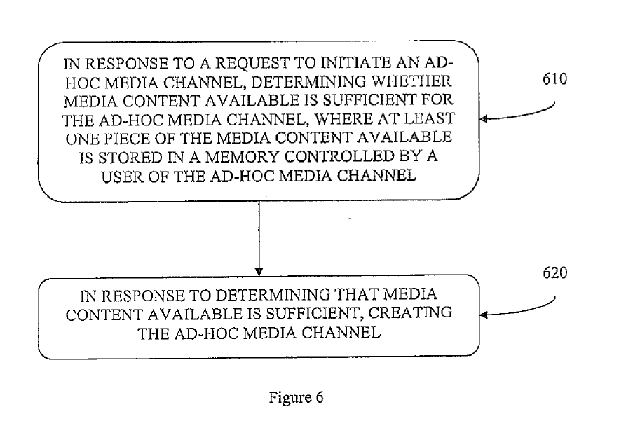

FIG. 6 is a logic flow diagram that illustrates the operation of a method, and a result of execution of computer program instructions, in accordance with exemplary embodiments. In accordance with these exemplary embodiments, in response to a request to initiate a media channel, a method performs, at Block 610, a step of determining whether media content available is sufficient for the media channel (such as by meeting one or more predetermined criteria). At least one piece of the media content available is stored in a memory controlled by a user of the media channel. In response to determining that media content available is sufficient, the method also performs, at Block 620, a step of, creating the media channel.

The various blocks shown in FIG. 6 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although not limited thereto. While various aspects of the exemplary embodiments may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

An exemplary embodiment provides a method for creating and managing ad-hoc context constrained media channels. The method includes, in response to a request to initiate a media channel, determining (such as by a processor) whether media content available for the media channel is relevant and/or sufficient. At least one piece of the media content available is stored in a memory controlled by a user of the media channel. The method also includes, in response to determining that media content available is relevant and/or sufficient, creating (such as by a processor) the media channel.

In a further exemplary embodiment of the method above, at least one additional piece of the media content available is stored in a memory controlled by an external service. The at least one additional piece of the media content available may include an advertisement message.

In another exemplary embodiment of any one of the methods above, the memory controlled by the user is a memory of a mobile device or a cloud storage memory.

In a further exemplary embodiment of any one of the methods above, the method also includes receiving at least one channel request and determining whether to make a request to initiate the media channel based on the at least one channel request.

In another exemplary embodiment of any one of the methods above, determining whether the media content available is relevant and/or sufficient includes determining whether a total playtime of the media content available exceeds a minimum time threshold and/or determining whether a total number of pieces of the media available exceeds a minimum threshold.

In a further exemplary embodiment of any one of the methods above, the method also includes selecting a first piece of the media from the at least one piece of the media content stored in the memory controlled by a user. Downloading the first piece and/or buffering the first piece is included in the method. The method also includes playing the first piece on the media channel.

In another exemplary embodiment of any one of the methods above, the method also includes, in response to completing the playing of the first piece on the media channel, deleting a downloaded copy of the first piece.

In a further exemplary embodiment of any one of the methods above, the method also includes receiving a request from a new user to access the media channel and receiving a list of new pieces of media content stored in a memory controlled by the new user. The method also includes determining whether to add at least one new piece of the new pieces of media content to the media content available for the media channel. The request and the list may be received in a single message. Alternatively, the request and the list may be received in separate messages. Determining whether to add the new pieces of media content to the media content available for the media channel may include determining whether a characteristic of the one new piece matches a characteristic of the media channel. The method may also include determining whether to add the at least one new piece of the new pieces of media content to media content available for another media channel.

In another exemplary embodiment of any one of the methods above, the method also includes receiving a request from a new user to access the media channel and determining whether to authorize access based on a location of the user, an activity of the user and/or whether the user is a member in a group associated with the media channel.

In a further exemplary embodiment of any one of the methods above, the method also includes, in response to determining that media content available is not sufficient, accessing an external service and adding at least one additional piece of media content to the available media content available. As a result of adding the at least one additional piece of media content, the modified available media content may now be deemed sufficient (such as by meeting one or more criteria which were not previously met).

Another exemplary embodiment provides an apparatus for creating and managing ad-hoc context constrained media channels. The apparatus includes at least one processor (such as DP 144); and at least one memory (such as MEM 146) storing computer program code (such as PROG 148). The at least one memory and the computer program code are configured to, with the at least one processor, cause the apparatus to perform actions. The actions include, in response to a request to initiate a media channel, to determine whether media content available for the media channel is relevant and/or sufficient. At least one piece of the media content available is stored in a memory controlled by a user of the media channel. The actions also include, in response to determining that media content available is relevant and/or sufficient, to create the media channel.

In a further exemplary embodiment of the apparatus above, at least one additional piece of the media content available is stored in a memory controlled by an external service. The at least one additional piece of the media content available may include an advertisement message.

In another exemplary embodiment of any one of the apparatus above, the memory controlled by the user is a memory of a mobile device or a cloud storage memory.

In a further exemplary embodiment of any one of the apparatus above, the actions also include to receive at least one channel request and to determine whether to make a request to initiate the media channel based on the at least one channel request.

In another exemplary embodiment of any one of the apparatus above, determining whether the media content available is relevant and/or sufficient includes to determine whether a total playtime of the media content available exceeds a minimum time threshold and/or to determine whether a total number of pieces of the media available exceeds a minimum threshold.

In a further exemplary embodiment of any one of the apparatus above, the actions also include to select a first piece of the media from the at least one piece of the media content stored in the memory controlled by a user. To download the first piece and/or to buffer the first piece are included in the actions. The actions also include to play the first piece on the media channel.

In another exemplary embodiment of any one of the apparatus above, the actions also include, in response to completing the playing of the first piece on the media channel, to delete a downloaded copy of the first piece.

In a further exemplary embodiment of any one of the apparatus above, the actions also include to receive a request from a new user to access the media channel and to receive a list of new pieces of media content stored in a memory controlled by the new user. The actions also include to determine whether to add at least one new piece of the new pieces of media content to the media content available for the media channel. The request and the list may be received in a single message. Alternatively, the request and the list may be received in separate messages. Determining whether to add the new pieces of media content to the media content available for the media channel may include to determine whether a characteristic of the one new piece matches a characteristic of the media channel. The actions may also include to determine whether to add the at least one new piece of the new pieces of media content to media content available for another media channel.

In another exemplary embodiment of any one of the apparatus above, the actions also include to receive a request from a new user to access the media channel and to determine whether to authorize access based on a location of the user, an activity of the user and/or whether the user is a member in a group associated with the media channel.

In a further exemplary embodiment of any one of the apparatus above, the actions also include, in response to determining that media content available is not sufficient, to access an external service and to add at least one additional piece of media content to the media content available. As a result of adding the at least one additional piece of media content, the modified available media content may now be deemed sufficient (such as by meeting one or more criteria which were not previously met).

In another exemplary embodiment of any one of the apparatus above, the apparatus is embodied in a mobile device.

In a further exemplary embodiment of any one of the apparatus above, the apparatus is embodied in an integrated circuit.

Another exemplary embodiment provides a computer readable medium (such as MEM 146) for creating and managing ad-hoc context constrained media channels. The computer readable medium is tangibly encoded with a computer program (such as PROG 148) executable by a processor (such as DP 144) to perform actions. The actions include, in response to a request to initiate a media channel, determining whether media content available for the media channel is relevant and/or sufficient. At least one piece of the media content available is stored in a memory controlled by a user of the media channel. The actions also include, in response to determining that media content available is relevant and/or sufficient, creating the media channel.

In a further exemplary embodiment of the computer readable medium above, at least one additional piece of the media content available is stored in a memory controlled by an external service. The at least one additional piece of the media content available may include an advertisement message.

In another exemplary embodiment of any one of the computer readable media above, the memory controlled by the user is a memory of a mobile device or a cloud storage memory.

In a further exemplary embodiment of any one of the computer readable media above, the actions also include receiving at least one channel request and determining whether to make a request to initiate the media channel based on the at least one channel request.

In another exemplary embodiment of any one of the computer readable media above, determining whether the media content available is relevant and/or sufficient includes determining whether a total playtime of the media content available exceeds a minimum time threshold and/or determining whether a total number of pieces of the media available exceeds a minimum threshold.

In a further exemplary embodiment of any one of the computer readable media above, the actions also include selecting a first piece of the media from the at least one piece of the media content stored in the memory controlled by a user. Downloading the first piece and/or buffering the first piece is included in the actions. The actions also include playing the first piece on the media channel.

In another exemplary embodiment of any one of the computer readable media above, the actions also include, in response to completing the playing of the first piece on the media channel, deleting a downloaded copy of the first piece.

In a further exemplary embodiment of any one of the computer readable media above, the actions also include receiving a request from a new user to access the media channel and receiving a list of new pieces of media content stored in a memory controlled by the new user. The actions also include determining whether to add at least one new piece of the new pieces of media content to the media content available for the media channel. The request and the list may be received in a single message. Alternatively, the request and the list may be received in separate messages. Determining whether to add the new pieces of media content to the media content available for the media channel may include determining whether a characteristic of the one new piece matches a characteristic of the media channel. The actions may also include determining whether to add the at least one new piece of the new pieces of media content to media content available for another media channel.

In another exemplary embodiment of any one of the computer readable media above, the actions also include receiving a request from a new user to access the media channel and determining whether to authorize access based on a location of the user, an activity of the user and/or whether the user is a member in a group associated with the media channel.

In a further exemplary embodiment of any one of the computer readable media above, the actions also include, in response to determining that media content available is not sufficient, accessing an external service and adding at least one additional piece of media content to the media content available. As a result of adding the at least one additional piece of media content, the modified available media content may now be deemed sufficient (such as by meeting one or more criteria which were not previously met).

In another exemplary embodiment of any one of the computer readable media above, the computer readable medium is a non-transitory computer readable medium (e.g., CD-ROM, RAM, flash memory, etc.).

In a further exemplary embodiment of any one of the computer readable media above, the computer readable medium is a storage medium.

Another exemplary embodiment provides an apparatus for creating and managing ad-hoc context constrained media channels. The apparatus includes means for determining (such as a processor) whether media content available for the media channel is relevant and/or sufficient in response to a request to initiate a media channel. At least one piece of the media content available is stored in a memory controlled by a user of the media channel. The apparatus also includes means for creating (such as a processor) the media channel in response to determining that media content available is relevant and/or sufficient.

In a further exemplary embodiment of the apparatus above, at least one additional piece of the media content available is stored in a memory controlled by an external service. The at least one additional piece of the media content available may include an advertisement message.

In another exemplary embodiment of any one of the apparatus above, the memory controlled by the user is a memory of a mobile device or a cloud storage memory.

In a further exemplary embodiment of any one of the apparatus above, the apparatus also includes means for receiving at least one channel request and means for determining whether to make a request to initiate the media channel based on the at least one channel request.

In another exemplary embodiment of any one of the apparatus above, the determining means includes means for determining whether a total playtime of the media content available exceeds a minimum time threshold and/or means for determining whether a total number of pieces of the media available exceeds a minimum threshold.

In a further exemplary embodiment of any one of the apparatus above, the apparatus also includes means for selecting a first piece of the media from the at least one piece of the media content stored in the memory controlled by a user. Means for downloading the first piece and/or means for buffering the first piece is included in the apparatus. The apparatus also includes means for playing the first piece on the media channel.

In another exemplary embodiment of any one of the apparatus above, the apparatus also includes means for deleting a downloaded copy of the first piece in response to completing the playing of the first piece on the media channel.

In a further exemplary embodiment of any one of the apparatus above, the apparatus also includes means for receiving a request from a new user to access the media channel and means for receiving a list of new pieces of media content stored in a memory controlled by the new user. The apparatus also includes means for determining whether to add at least one new piece of the new pieces of media content to the media content available for the media channel. The request and the list may be received in a single message. Alternatively, the request and the list may be received in separate messages. The determining means may include means for determining whether a characteristic of the one new piece matches a characteristic of the media channel. The apparatus may also include means for determining whether to add the at least one new piece of the new pieces of media content to media content available for another media channel.

In another exemplary embodiment of any one of the apparatus above, the apparatus also includes means for receiving a request from a new user to access the media channel and means for determining whether to authorize access based on a location of the user, an activity of the user and/or whether the user is a member in a group associated with the media channel.

In a further exemplary embodiment of any one of the apparatus above, the apparatus also includes means for accessing an external service and means for adding at least one additional piece of media content to the media content available in response to determining that media content available is not sufficient. As a result of adding the at least one additional piece of media content, the modified available media content may now be deemed sufficient (such as by meeting one or more criteria which were not previously met).

Another exemplary embodiment provides a method for creating and managing ad-hoc context constrained media channels. The method includes generating (such as by a processor) a list of pieces of media content stored in a memory. The list includes an indication of at least one piece of media content that is authorized to be shared. The method also includes sending (such as by a transmitter) the list to a media channel server.

In a further exemplary embodiment of the method above, the method includes receiving, from the media channel server, a request for a selected piece of media content; and sending the selected piece of media content to the media channel server. Alternatively, the method includes receiving, from the media channel server, a request for a selected piece of media content; and providing access to the selected piece of media content to the media channel server. Providing access to the selected piece of media content may include authorizing the media channel server to access a cloud memory.

In another exemplary embodiment of any one of the methods above, the memory is one of: an external server, a memory of a mobile device controlled by a user and a cloud storage memory controlled by the user.

In a further exemplary embodiment of any one of the methods above, the method also includes sending a request to initiate a media channel

In another exemplary embodiment of any one of the methods above, the method also includes sending a request to access a media channel. The method may also include, in response to sending the request, receiving an authorization for the media channel. The authorization for the media channel may include access parameters for the media channel.

In a further exemplary embodiment of any one of the methods above, the method also includes receiving an authorized to share the at least one piece of media content.

In another exemplary embodiment of any one of the methods above, the method also includes determining whether media content available for the media channel meets at least one predetermined criterion. Generating the list of pieces of media content stored in a memory is performed in response to determining that the media channel does not have sufficient media content to meet at least one predetermined criterion. Determining whether the media content available for the media channel meets the at least one predetermined criterion may include receiving a report from the media channel server.

A further exemplary embodiment provides an apparatus for creating and managing ad-hoc context constrained media channels. The apparatus includes at least one processor (such as DP 114); and at least one memory (such as MEM 116) storing computer program code (such as PROG 118). The at least one memory and the computer program code are configured to, with the at least one processor, cause the apparatus to perform actions. The actions include to generate a list of pieces of media content stored in a memory. The list includes an indication of at least one piece of media content that is authorized to be shared. The actions also include to send the list to a media channel server.

In another exemplary embodiment of the apparatus above, the actions include to receive, from the media channel server, a request for a selected piece of media content; and to send the selected piece of media content to the media channel server. Alternatively, the actions include to receive, from the media channel server, a request for a selected piece of media content; and to provide access to the selected piece of media content to the media channel server. Providing access to the selected piece of media content may include authorizing the media channel server to access a cloud memory.

In a further exemplary embodiment of any one of the apparatus above, the memory is one of: an external server, a memory of a mobile device controlled by a user and a cloud storage memory controlled by the user.

In another exemplary embodiment of any one of the apparatus above, the actions also include to send a request to initiate a media channel

In a further exemplary embodiment of any one of the apparatus above, the actions also include to send a request to access a media channel. The actions may also include, in response to sending the request, to receive an authorization for the media channel. The authorization for the media channel may include access parameters for the media channel.

In another exemplary embodiment of any one of the apparatus above, the actions also include to receive an authorized to share the at least one piece of media content.

In a further exemplary embodiment of any one of the apparatus above, the actions also include to determine whether media content available for the media channel meets at least one predetermined criterion. Generating the list of pieces of media content stored in a memory is performed in response to determining that the media channel does not have sufficient media content to meet at least one predetermined criterion. Determining whether the media content available for the media channel meets the at least one predetermined criterion may include receiving a report from the media channel server.

In another exemplary embodiment of any one of the apparatus above, the apparatus is embodied in a mobile device.

In a further exemplary embodiment of any one of the apparatus above, the apparatus is embodied in an integrated circuit.

Another exemplary embodiment provides a computer readable medium (such as MEM 116) for creating and managing ad-hoc context constrained media channels. The computer readable medium is tangibly encoded with a computer program (such as PROG 118) executable by a processor (such as DP 114) to perform actions. The actions include generating a list of pieces of media content stored in a memory. The list includes an indication of at least one piece of media content that is authorized to be shared. The actions also include sending the list to a media channel server.

In a further exemplary embodiment of the computer readable medium above, the actions include receiving, from the media channel server, a request for a selected piece of media content; and sending the selected piece of media content to the media channel server. Alternatively, the actions include receiving, from the media channel server, a request for a selected piece of media content; and providing access to the selected piece of media content to the media channel server. Providing access to the selected piece of media content may include authorizing the media channel server to access a cloud memory.

In another exemplary embodiment of any one of the computer readable media above, the memory is one of: an external server, a memory of a mobile device controlled by a user and a cloud storage memory controlled by the user.

In a further exemplary embodiment of any one of the computer readable media above, the actions also include sending a request to initiate a media channel

In another exemplary embodiment of any one of the computer readable media above, the actions also include sending a request to access a media channel. The actions may also include, in response to sending the request, receiving an authorization for the media channel. The authorization for the media channel may include access parameters for the media channel.

In a further exemplary embodiment of any one of the computer readable media above, the actions also include receiving an authorized to share the at least one piece of media content.

In another exemplary embodiment of any one of the computer readable media above, the actions also include determining whether media content available for the media channel meets at least one predetermined criterion. Generating the list of pieces of media content stored in a memory is performed in response to determining that the media channel does not have sufficient media content to meet at least one predetermined criterion. Determining whether the media content available for the media channel meets the at least one predetermined criterion may include receiving a report from the media channel server.

In a further exemplary embodiment of any one of the computer readable media above, the computer readable medium is a non-transitory computer readable medium (e.g., CD-ROM, RAM, flash memory, etc.).

In another exemplary embodiment of any one of the computer readable media above, the computer readable medium is a storage medium.

A further exemplary embodiment provides an apparatus for creating and managing ad-hoc context constrained media channels. The apparatus includes means for generating (such as a processor) a list of pieces of media content stored in a memory. The list includes an indication of at least one piece of media content that is authorized to be shared. The apparatus also includes means for sending (such as a transmitter) the list to a media channel server.

In another exemplary embodiment of the apparatus above, the apparatus includes means for receiving, from the media channel server, a request for a selected piece of media content; and means for sending the selected piece of media content to the media channel server. Alternatively, the apparatus includes means for receiving, from the media channel server, a request for a selected piece of media content; and means for providing access to the selected piece of media content to the media channel server. The access providing means may include means for authorizing the media channel server to access a cloud memory.

In a further exemplary embodiment of any one of the apparatus above, the memory is one of an external server, a memory of a mobile device controlled by a user and a cloud storage memory controlled by the user.

In another exemplary embodiment of any one of the apparatus above, the apparatus also includes means for sending a request to initiate a media channel

In a further exemplary embodiment of any one of the apparatus above, the apparatus also includes means for sending a request to access a media channel. The apparatus may also include means for receiving an authorization for the media channel in response to sending the request. The authorization for the media channel may include access parameters for the media channel.

In another exemplary embodiment of any one of the apparatus above, the apparatus also includes means for receiving an authorized to share the at least one piece of media content.

In a further exemplary embodiment of any one of the apparatus above, the apparatus also includes means for determining whether media content available for the media channel meets at least one predetermined criterion. Generating the list of pieces of media content stored in a memory is performed in response to determining that the media channel does not have sufficient media content to meet at least one predetermined criterion. The means for determining whether the media content available for the media channel meets the at least one predetermined criterion may include means for receiving a report from the media channel server.

It should thus be appreciated that at least some aspects of the exemplary embodiments may be practiced in various components such as integrated circuit chips and modules, and that the exemplary embodiments may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments.

Various modifications and adaptations to the foregoing exemplary embodiments may become apparent to those skilled in the relevant arts in view of the foregoing description, when read in conjunction with the accompanying drawings. However, any and all modifications will still fall within the scope of the non-limiting and exemplary embodiments.

For example, while the exemplary embodiments have been described above in the context of music sharing, it should be appreciated that the exemplary embodiments are not limited for use with only audio data, and that they may be used to advantage for other media data such as for example, video data, audio recording data, etc. Similarly, the exemplary embodiments are not limited for use with only a music channel/radio, and they may be used to advantage for other media channels/radios such as for example, video channel/radio, audio channel/radio, etc.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments may be used to advantage without the corresponding use of other features. As such, the foregoing description should be considered as merely illustrative of the principles, teachings and exemplary embodiments, and not in limitation thereof.

1-100. (canceled)

101. A method comprising:
in response to a request to initiate a media channel, determining whether media content available for the media channel meets at least one predetermined criterion, where at least one piece of the media content available is stored in a memory controlled by a user of the media channel; and
in response to determining that the media content available meets the at least one predetermined criterion, creating the media channel.

102. A method according to claim 101, further comprising:
receiving at least one channel request; and
determining, based on the at least one channel request, whether to make a request to initiate the media channel,
wherein at least one additional piece of the media content available is stored in a memory controlled by an external service, the at least one additional piece of the media content available comprises an advertisement message and where memory controlled by the user is one of: a memory of a mobile device and a cloud storage memory.

103. A method according to claim 101, where determining whether the media content available meets the at least one predetermined criterion comprises at least one of: determining whether a total playtime of the media content available exceeds a minimum time threshold and determining whether a total number of pieces of the media available exceeds a minimum threshold.

104. A method according to claim 101, further comprising:
selecting a first piece of the media from the at least one piece of the media content stored in the memory controlled by a user;
downloading the first piece and buffering the first piece;
playing the first piece on the media channel; and
in response to completing the playing of the first piece on the media channel, deleting a downloaded copy of the first piece, the method further comprising:
receiving a request from a new user to access the media channel;
receiving a list of new pieces of media content stored in a memory controlled by the new user;
determining whether to add at least one new piece of the new pieces of media content to the media content available for the media channel or for another media channel, where determining whether to add the new pieces of media content to the media content available for the media channel comprises determining whether a characteristic of the one new piece matches a characteristic of the media channel.

105. A method according to claim 101, further comprising:
receiving a request from a new user to access the media channel; and
determining whether to authorize access based on at least one of: a location of the user, an activity of the user and whether the user is a member in a group associated with the media channel.

106. A computer readable medium tangibly encoded with a computer program executable by a processor to perform actions comprising:
in response to a request to initiate a media channel, determining whether media content available for the media channel meets at least one predetermined criterion, where at least one piece of the media content available is stored in a memory controlled by a user of the media channel; and
in response to determining that the media content available meets the at least one predetermined criterion, creating the media channel.

107. A computer readable medium according to claim 106, the actions further comprising:
receiving at least one channel request; and
determining, based on the at least one channel request, whether to make a request to initiate the media channel,
where at least one additional piece of the media content available is stored in a memory controlled by an external service, where the at least one additional piece of the media content available comprises an advertisement message and where the memory controlled by the user is one of: a memory of a mobile device and a cloud storage memory.

108. A computer readable medium according to claim 106, where determining whether the media content available meets the at least one predetermined criterion comprises at least one of: determining whether a total playtime of the media content available exceeds a minimum time threshold and determining whether a total number of pieces of the media available exceeds a minimum threshold.

109. A computer readable medium according to at least one of claim 106, where the actions further comprise:
selecting a first piece of the media from the at least one piece of the media content stored in the memory controlled by a user;
at least one of: downloading the first piece and buffering the first piece;
playing the first piece on the media channel;
receiving a request from a new user to access the media channel;
receiving a list of new pieces of media content stored in a memory controlled by the new user; and
determining whether to add at least one new piece of the new pieces of media content to the media content available for the media channel or for another media channel
in response to completing the playing of the first piece on the media channel, deleting a downloaded copy of the first piece, where determining whether to add the new pieces of media content to the media content available for the media channel comprises determining whether a characteristic of the one new piece matches a characteristic of the media channel.

110. A computer readable medium according to claim 106, where the actions further comprise:
receiving a request from a new user to access the media channel; and
determining whether to authorize access based on at least one of: a location of the user, an activity of the user and whether the user is a member in a group associated with the media channel.

111. An apparatus, comprising: at least one processor; and at least one memory including computer program code, the at least one memory and the computer program code configured to, with the at least one processor, cause the apparatus to perform at least the following:
to determine whether media content available for the media channel meets at least one predetermined criterion in response to a request to initiate a media channel, where at least one piece of the media content available is stored in a memory controlled by a user of the media channel; and
to create the media channel in response to determining that the media content available meets the at least one predetermined criterion.

112. An apparatus according to claim 111, where the at least one memory and the computer program code are further configured to cause the apparatus:
to receive at least one channel request;
to determine, based on the at least one channel request, whether to make a request to initiate the media channel and
where at least one additional piece of the media content available is stored in a memory controlled by an external service, where the at least one additional piece of the media content available comprises an advertisement message and where the memory controlled by the user is one of: a memory of a mobile device and a cloud storage memory.

113. An apparatus according to claim 111, where, when determining whether the media content available meets the at least one predetermined criterion, the at least one memory and the computer program code are further configured to cause the apparatus to at least one of: determine whether a total playtime of the media content available exceeds a minimum time threshold and determine whether a total number of pieces of the media available exceeds a minimum threshold.

114. An apparatus according to claim 111, where the at least one memory and the computer program code are further configured to cause the apparatus:
to select a first piece of the media from the at least one piece of the media content stored in the memory controlled by a user;
at least one of: to download the first piece and to buffer the first piece;
to play the first piece on the media channel;
to receive a request from a new user to access the media channel;
to receive a list of new pieces of media content stored in a memory controlled by the new user;
to determine whether to add at least one new piece of the new pieces of media content to the media content available for the media channel and
when determining whether to add the new pieces of media content to the media content available for the media channel, the at least one memory and the computer program code are further configured to cause the apparatus to determine whether a characteristic of the one new piece matches a characteristic of the media channel and to cause the apparatus to determine whether to add the at least one new piece of the new pieces of media content to media content available for another media channel, where the at least one memory and the computer program code are further configured to cause the apparatus, in response to completing the playing of the first piece on the media channel, to delete a downloaded copy of the first piece.

115. An apparatus according to claim 111, where the at least one memory and the computer program code are further configured to cause the apparatus:
to receive a request from a new user to access the media channel; and
to determine whether to authorize access based on at least one of: a location of the user, an activity of the user and whether the user is a member in a group associated with the media channel.

116. An apparatus according to claim 111, where the at least one memory and the computer program code are further configured to cause the apparatus, in response to determining that media content available does not meet the at least one predetermined criterion, to access an external service and to add at least one additional piece of media content to the media content available.
